(19) United States
(12) Patent Application Publication
(10) Pub. No.: US 2006/0054216 A1
(43) Pub. Date: Mar. 16, 2006

(54) Compressed gas container and apparatus

(75) Inventor: Hiroshi Inoue, Yokohama-shi (JP)

Correspondence Address: OSTROLENK FABER GERB & SOFFEN, 1180 AVENUE OF THE AMERICAS, NEW YORK, NY, 100368403, US

(73) Assignee: Anest Iwata Corporation

(21) Appl. No.: 11/222,421

(22) Filed: Sep. 8, 2005

(30) Foreign Application Priority Data
Sep. 10, 2004 (JP) 2004-263656

(51) Int. Cl. E03B 11/00; F17D 1/00

(52) U.S. Cl. 137/255; 137/257

(57) ABSTRACT

A compressed gas tank comprises a cylindrical body and mirror plates at the ends of the cylindrical body. A fastening rod puts through the center of the tank longitudinally. A nut is engaged at one end of the rod, such that the tank is pressingly connected with the mirror plates without welding. The tank has a communicating hole at the circumference. A plurality of tanks is supported by support openings of a cylinder block to form a compressed gas apparatus. The communicating hole of the tank communicates with a gas-guiding hole of the cylinder block connected to a gas compressor.

### BACKGROUNG OF THE INVENTION

The present invention relates to a compressed gas container for storing a compressed gas such as compressed air and a compressed gas apparatus comprising a plurality of compressed gas containers.

In a unit-type compressed gas equipment in which an electric motor and a gas compressor or a compressed-gas-actuating equipment (hereinafter referred to “a compressed gas equipment”) is connected to a compressed gas tank, in order to decrease a whole occupied area and facilitate transportation and handling, the compressed gas tank is likely to be disposed under the compressed gas equipment.

To make the whole apparatus as low as possible, an elongate compressed gas tank is horizontally disposed and a compressed gas equipment is placed thereon.

FIG. 9 is a perspective view showing one example of such an apparatus in which two cylindrical compressed gas tanks 101,101 having relatively small diameter, the same shape and the same size are arranged side by side. The opposing side surfaces of the tanks 101,101 are connected to each other by a communicating pipe 102, and the upper surfaces are connected to each other by support plates 103 to 105 for the compressed gas equipment.

An air compressor 106 is mounted on the support plates 103,104 and an electric motor 107 is mounted on the support plate 105.

The front surfaces of the compressed gas tanks 101,101 are connected to each other by a U-shaped handle 108, and the rear surfaces are connected to each other by another U-shaped handle 108.

Two bearing pieces 109, 109 are mounted to the outer lower surface of each of the tanks 101,101, and a wheel shaft 111 for a wheel 110 protrudes from each of the bearing piece 109. Meanwhile, a compressed gas intake port 112 is formed on the upper surface of the compressed gas tank 101 and a compressed gas discharge port 113 is formed on the upper surface. A drain outlet 114 is formed on the lower portion of the tank 101.

The side edges of a cylindrical body 101a into which a metal plate is rolled up are welded to each other and a mirror plate 101 is welded on an opening of the each end of the cylindrical body 101a to produce the compressed gas tank 101. The communicating pipe 102, the compressed gas equipment, the support plates 103 to 105, the handle 108, the beating piece 109, the compressed gas intake port 112, the compressed gas discharge port 113 and the drain outlet 114 are all welded to the compressed gas tank 101.

Such a conventional compressed gas tank is hermetically manufactured by welding and has a number of welded portions thereby requiring a number of working steps and maintenance. Heat strain generates to result in poor conformity with materials and cracks are likely to occur in the compressed gas tank with use. Thus, it is required to use thick materials thereby increasing price and weight with the attached members.

In order to keep a total height and a center of gravity of the compressed gas tank and the compressed gas equipment thereon as low as possible, the compressed gas tank is made as narrow as possible and the number increases with increase parallel arrangement. However, the adjacent compressed gas tanks 101,101 are allowed to communicate with each other through the communicating pipe 102 in which a gas passes. If one of the tanks 101 becomes impossible in use owing to leakage or cracking, the other one having no abnormality has to be scrapped which is uneconomical.

A plurality of compressed gas tanks that are fixed by welding cannot be partially replaced with a different volume tank. Furthermore, even if the bearing piece or handle attached to the tank is excessively deformed or broken, only the tank cannot be replaced with a new one.

### SUMMARY OF THE INVENTION

In view of the disadvantages in the prior art, it is an object of the invention to provide a compressed gas container having no welded portions.

It is another object of the invention to provide a compressed gas apparatus in which a plurality of compressed gas containers or tanks having the same shape and the same size in section are arranged side by side to allow the tanks to communicate with each other.

It is a further object of the invention to provide a compressed gas apparatus having different volume containers or tanks which can be replaced with a different-length compressed gas tank.

It is yet another object of the invention to provide a compressed gas apparatus in which compressed gas containers are supported while the containers communicate with each other.

### BRIEF DESCRIPTION OF THE DRAWINGS

The above and other features and advantages of the invention will become more apparent from the following description with respect to embodiments shown in appended drawings wherein:

FIG. 1 is a side elevational view of an embodiment of a compressed gas container according to the present invention;

FIG. 2 is an enlarged vertical sectional view showing an example of a connecting portion between a body and a mirror plate of the compressed gas container in FIG. 1;

FIG. 3 is an enlarged vertical sectional view showing another example of a connecting portion between the body and the mirror plate of the compressed gas container in FIG. 1;

FIG. 4 is an enlarged vertical sectional view showing further example of a connecting portion between the body and the mirror plate of the compressed gas container in FIG. 1;

FIG. 5 is an enlarged vertical sectional view showing yet another example of a connecting portion between the body and the mirror plate of the compressed gas container in FIG. 1;

FIG. 6 is an enlarged vertical sectional view showing a still further example of a connecting portion between the body and the mirror plate of the compressed gas container in FIG. 1;

FIG. 7 is a perspective view of an embodiment of a compressed gas apparatus according to the present invention;

FIG. 8 is an enlarged vertical sectional view taken along the line VIII-VIII in FIG. 7; and

FIG. 9 is a perspective view showing an example of a conventional compressed gas apparatus.

### DETAILED DESCRIPTION OF PREFERRED EMBODIMENT

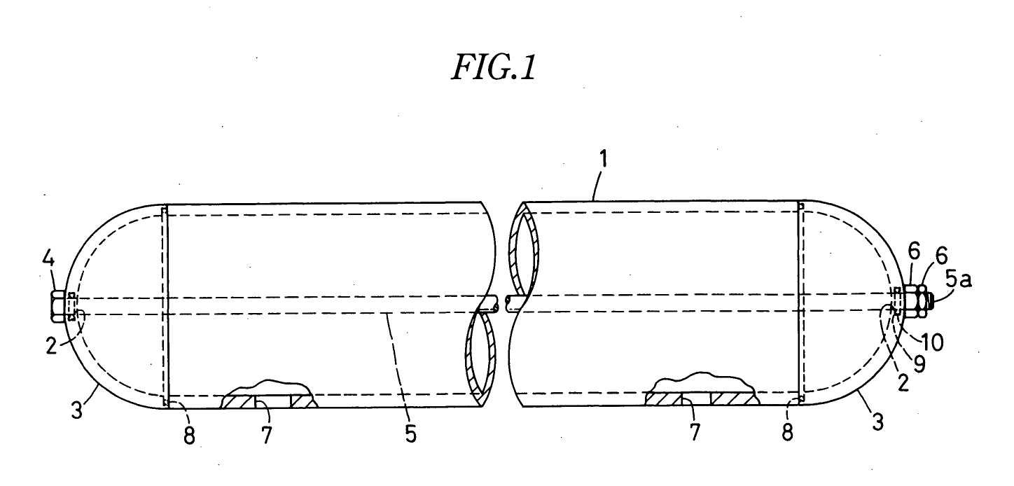

FIGS. 1 to 6 show different embodiments of a compressed gas container according to the present invention.

A metal pipe such as a seamless steel pipe having desired diameter and thickness is cut to a desired length to form a tubular body 1. At each end of the tubular body 1, a bowl-shaped mirror plate 3 has an axial hole 2 through which a fastening rod 5 having a larger-diameter head 4 at one end extends. Double nuts 6,6 engage with a thread 5a of the fastening rod 5 which projects from the mirror plate 3.

The mirror plate 3 provides axial elasticity for preventing rotation of the double nuts 6,6. At the underside of the tubular body 1, there is formed a communicating hole 7 to allow the tubular body 1 to communicate with another similar tank for a compressed gas. How to communicate will be described later.

The tubular body 1 is connected to the mirror plate 3 with the flat surface with a flat annular packing 8 therebetween. An annular groove 9 is radially formed on the inner surface of the axial hole 2 of the mirror plate 3. An O-ring 10 fits in the annular groove 9 to keep air tightness with the fastening rod 5.

The opening end of the mirror plate 3 is pressingly mounted to the end of the tubular body 1 with the double nuts 6,6 elastically and hermetically.

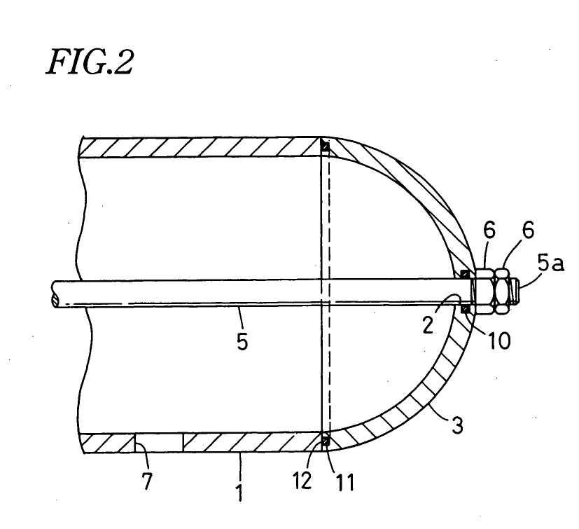

FIG. 2 shows that an annular groove 11 is formed on one or both of the end faces which allow a tubular body 1 to contact a mirror plate 3, and an O-ring 12 fits in the annular groove 11.

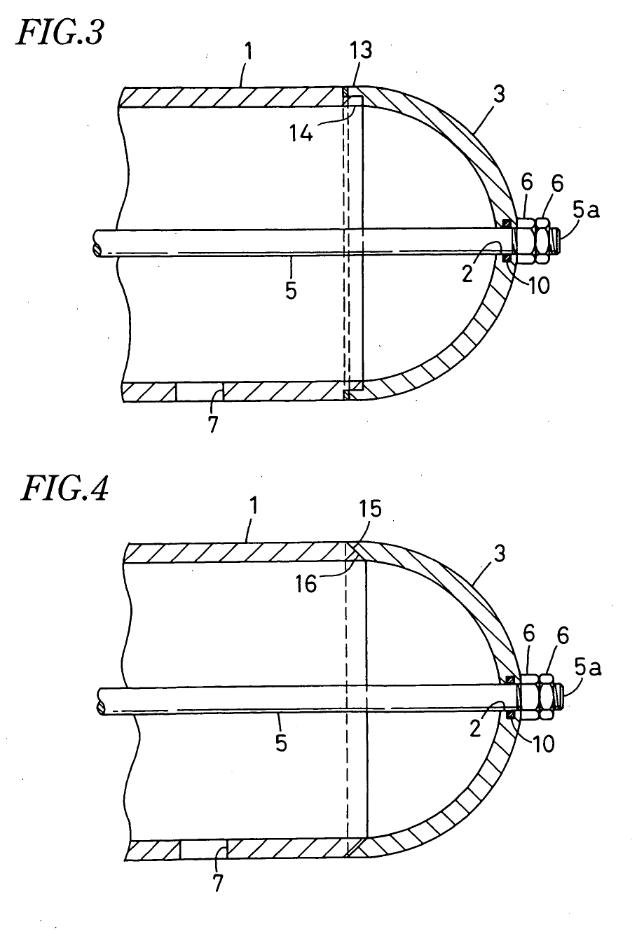

FIGS. 3 to 6 show embodiments in which the end faces which allow the tubular body 1 to connect to the mirror plate 3 pressingly and firmly avoid necessity of a packing or renders dependence on a packing smaller. In FIG. 3, on the opposing end faces of the tubular body 1 and the mirror plate 3, engagement portions 13,14 that engage with each other are provided to keep air tightness. The engagement portions 13,14 are slightly inclined in a radial direction. As the mirror plate 3 engages with the end of the tubular body 1, the inclined surfaces are in sliding contact with each other firmly to improve air tightness.

FIG. 4 shows that inclined surfaces 15,16 are formed on the opposing end faces of the tubular body 1 and the mirror plate 3.

The mirror plate 3 is fastened onto the inclined surface 16 of the tubular body 1 to increase adherence and to prevent the opening end of the tubular body 6 from expanding owing to internal pressure.

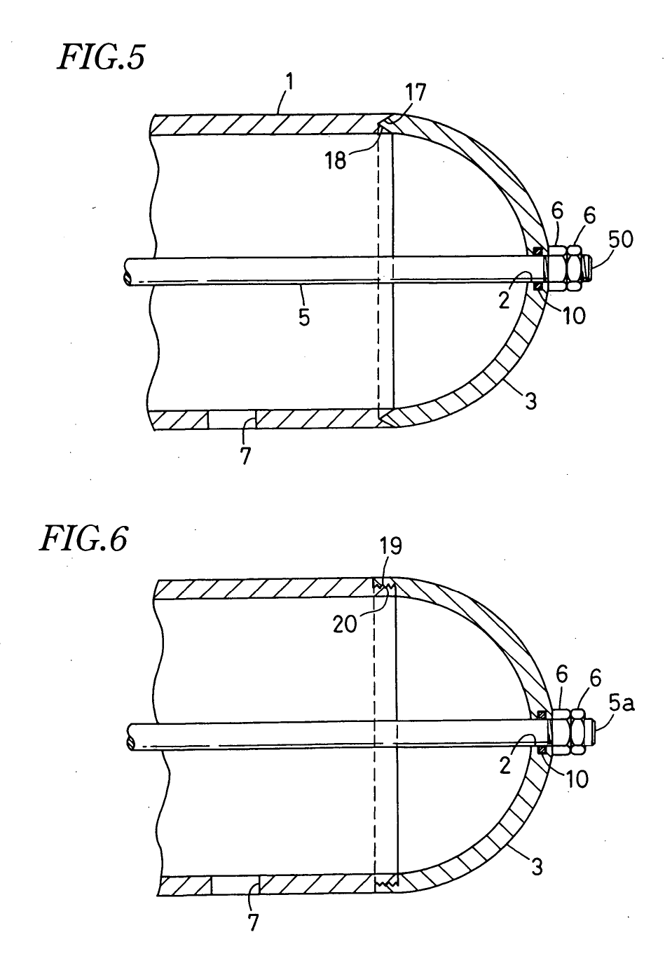

FIG. 5 shows that an annular triangular groove 17 of the end face of the tubular body 1 engages with an annular triangular projection 18 of the end face of the mirror plate 3.

FIG. 6 shows that a thread 19 of the tubular body 1 engages with a thread 20 of the mirror plate 3 to assure firm connection.

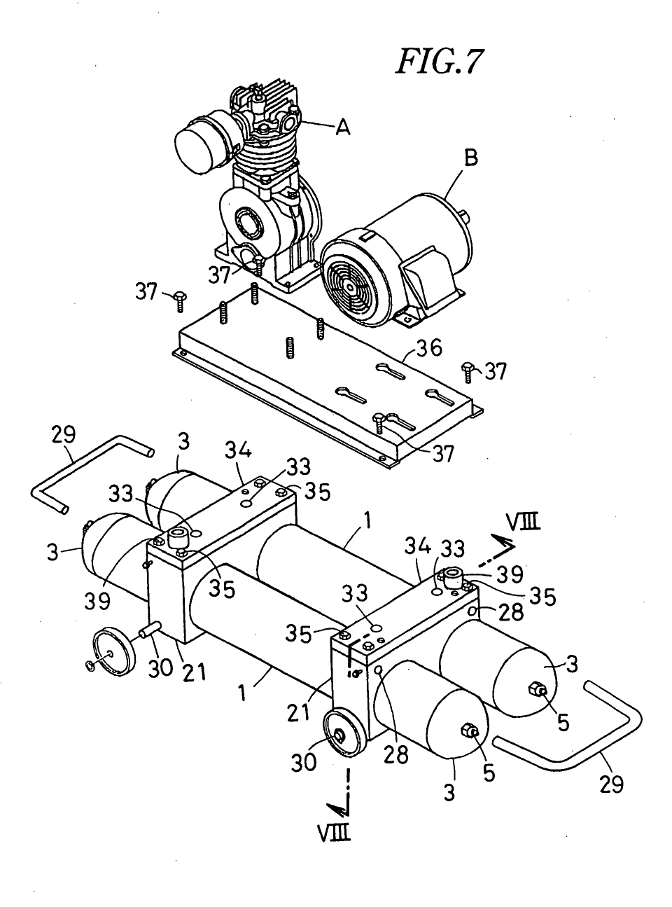

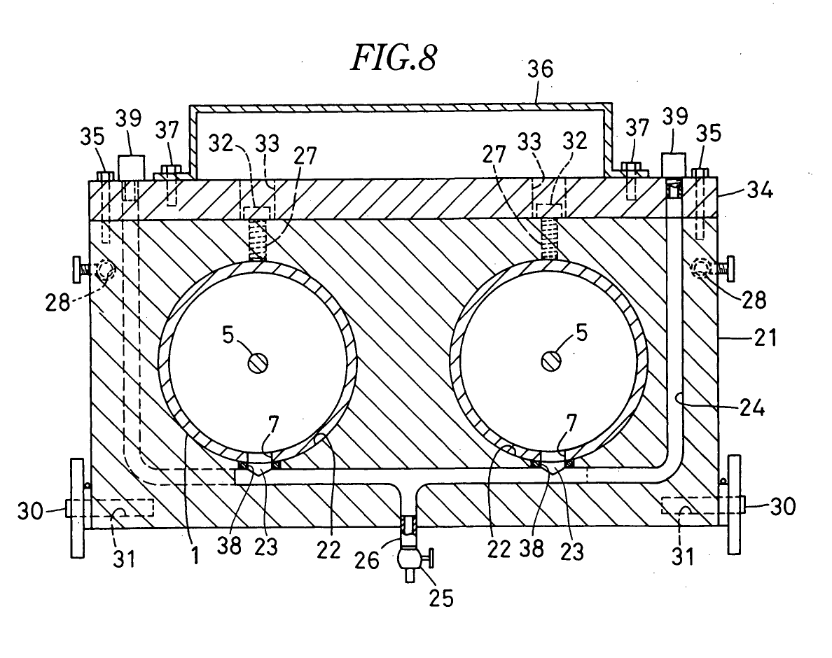

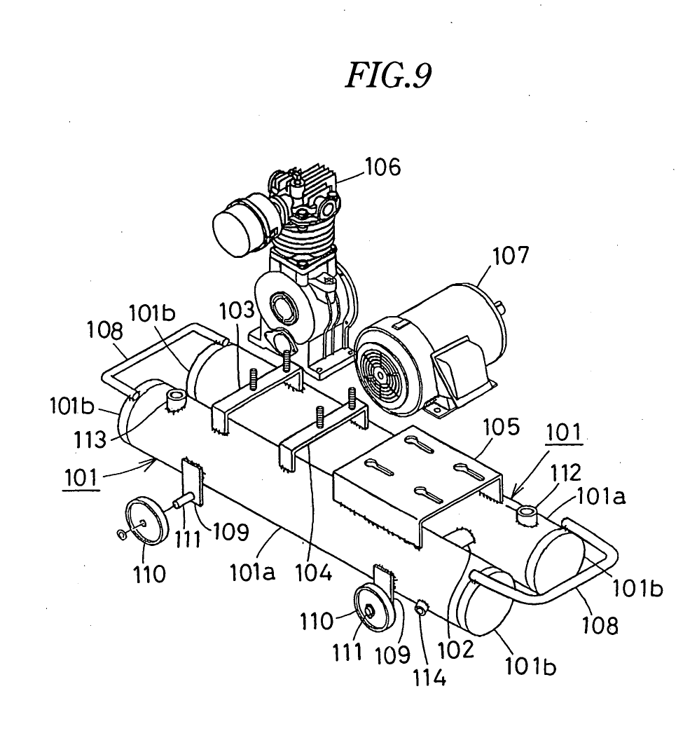

FIGS. 7 and 8 show two compressed gas tanks having the same shape and size and communicating to each other without any working. The two compressed gas tanks are held through support openings 22,22 of support blocks 21,21 spaced from each other axially. The support blocks 21,21 are made of a rectangular parallelepiped or a thick elliptical disc.

FIG. 8 is a vertical sectional view taken along the line VIII-VIII of the front support block 21 in FIG. 7 and the following holes are formed therein.

(a) Right-and-left holes 22 in which the compressed gas tanks fit.

(b) An L-shaped gas guiding hole 24 which has connecting holes 23,23 on the upper surface communicating with the support openings 22,22 to connect the lower ends of the support openings 22,22 to each other, one end of the guiding hole 24 terminating beyond the bottom of the support opening 22, while the other end opens upward.

(c) A drain discharge hole 26 with a valve 25 extending downward from the gas-guiding hole 24.

(d) A thread bore 27 that reaches to the top of the support opening 22.

(e) Holes 28,28 in which handles 29 fit.

(f) Support openings 31,31 in which wheel shafts 30 fit.

(g) A thread bore for preventing the handle 29 from losing or for mounting a top plate or a support plate.

If the holes and bores are difficult to be formed by machining, the support block 21 may be produced by die casting, may comprise separate elements or may be cast after hole-forming pipes may be embedded.

On the support block 21, there is provided a top plate 34 having the upper end of the gas-guiding hole 24, communicating holes 33,33 that match the thread bores 27,27, and openings 33,33.

On the top plate 34, a support plate 36 is fixed with a screw 37 to support compressed gas equipments such as a gas compressor “A” and an electric motor “B” for driving it. After a packing 38 is put on the connecting hole 23 that communicates with the gas-guiding hole 23, the body 1 of the compressed gas tank is inserted while the communicating hole 7 is placed at the bottom, a fastening screw 32 is inserted into the thread bore 27 at the top of the support opening 22, thereby pressing the body 1 onto the lower surface of the support opening 22.

Thus, the communicating hole 7 at the bottom of the body 1 hermetically coincides with the connecting hole 23. A top opening of the gas-guiding hole 24 is connected to the gas compressor “A” or any other compressed gas source via a cap 39 on the top plate 39.

According to the same procedures, more than two compressed gas tanks can be supported in the support blocks. The compressed gas tanks can be replaced with that having the same diameter and different length.

The foregoing merely relates to embodiments of the invention. Various changes and modifications may be made by a person skilled in the art without departing from the scope of claims wherein:

What is claimed is:

1. A compressed gas container comprising:
a cylindrical body having opening ends and a gas-guiding hole at a circumference;
a fastening rod one end of which having a larger-diameter head, the other end having an external thread, said rod extending axially of the body;
a first mirror plate that contacts one opening end of the body, has a first axial hole from which the larger-diameter head of the rod projects; and
a second mirror plate that contacts the other opening end of the body and has a second axial hole from which the external thread of the rod projects, a nut being fitted on the external thread of the rod so that the first and second mirror plates are strongly pressed onto the cylindrical body to assure firm engagement of the body with the first and second mirror plates.

2. A compressed gas container of claim 1 wherein the mirror plate provides axial elasticity to prevent the nut from rotation.

3. A compressed gas container of claim 1 wherein the compressed gas container comprises a compressed air tank.

4. A compressed gas container of claim 1 wherein a sealing material is inserted between the cylindrical body and the first and/or second mirror plate.

5. A compressed gas container of claim 4 wherein the sealing material comprises an O-ring.

6. A compressed gas container of claim 1 wherein a stepped portion of the cylindrical body engages with a stepped portion of the first and/or second mirror plate.

7. A compressed gas container of claim 1 wherein an inclined portion of the cylindrical body engages With an inclined portion of the first and/or second mirror plate.

8. A compressed gas container of claim 1 wherein a triangular groove of the cylindrical body engages with a triangular projection of the first and/or second mirror plate.

9. A compressed gas container of claim 1 wherein a thread of the cylindrical body engages with a thread of the first and/or second mirror plate.

10. A compressed gas apparatus comprising:
a compressed gas tank having a communicating hole; and
a support block having a horizontal support opening through which the compressed gas tank puts, and a gas-guiding hole connected to a gas compressor to allow the communicating hole to communicate with the gas-guiding hole of the support block.

11. A compressed gas apparatus of claim 10 wherein the compressed gas tank is supported and fixed in the support opening of the support block by pressing the tank radially to allow the communicating hole of the tank properly to communicate with the gas-guiding hole of the support block properly.

12. A compressed gas apparatus of claim 11 wherein the compressed gas tank is pressed at a top by a fastening screw threaded radially to allow the communicating hole of the tank properly to communicate with the gas-guiding hole of the support block properly.
